(19) United States
(12) Patent Application Publication
(10) Pub. No.: US 2013/0120221 A1
(43) Pub. Date: May 16, 2013

(54) Center Offset Fed Multiband Monopole Antenna and Portable Radio Communication Device Comprising Such An Antenna

(71) Applicants: Peter Lindberg, Uppsala (SE); Andrei Kaikkonen, Jarfalla (SE); Lukasz Grynczel, Upplands Vasby (SE)

(72) Inventors: Peter Lindberg, Uppsala (SE); Andrei Kaikkonen, Jarfalla (SE); Lukasz Grynczel, Upplands Vasby (SE)

(21) Appl. No.: 13/738,699

(22) Filed: Jan. 10, 2013

Related U.S. Application Data
(63) Continuation-in-part of application No. PCT/EP2010/064073, filed on Sep. 23, 2010.

(51) Int. Cl. H01Q 9/20

(52) U.S. Cl. CPC H01Q 9/20
USPC 343/900

(57) ABSTRACT

Exemplary embodiments are disclosed of antenna devices for portable radio communication devices. In an exemplary embodiment, an antenna device comprises a monopole radiating element to be positioned along one end of a portable radio communication device, for operation of a plurality of complementary frequency bands including the FM frequency band. A feed offset positioned on the monopole radiating element divides the monopole radiating element in a first part and a second part to provide at least one complementary frequency band additional to the FM frequency band. The FM frequency band and the at least one additional complementary frequency band are fed through the feed.

### CROSS-REFERENCE TO RELATED APPLICATION

This application is a continuation of PCT International Patent Application No. PCT/EP2010/064073 filed Sep. 23, 2010, published as WO 2012/037977 on Mar. 29, 2012. The entire disclosure of the above application is incorporated herein by reference.

### FIELD

The present disclosure relates generally to antenna devices and more particularly to an antenna device for a portable radio communication device, such as a mobile phone.

### BACKGROUND

This section provides background information related to the present disclosure which is not necessarily prior art.

In portable radio communication devices, such as mobile phones, cellular antennas are often positioned in the lower end of the mobile phone to be positioned as far away from a user talking in the phone as possible. Complementary antennas, such as FM (Frequeny Modulation), BT (Bluetooth), or GPS (Global Position System) antennas are in such phones often positioned in the opposite upper end, where available space exists for such complementary antennas.

The available space for a plurality of complementary antennas is thus limited. This makes it difficult to provide adequate function for a plurality of complementary antennas in a portable radio communication device, such as a mobile phone.

### SUMMARY

This section provides a general summary of the disclosure, and is not a comprehensive disclosure of its full scope or all of its features

Exemplary embodiments are disclosed of antenna devices for portable radio communication devices. In an exemplary embodiment, an antenna device comprises a monopole radiating element to be positioned along one end of a portable radio communication device, for operation of a plurality of complementary frequency bands including the FM frequency band. A feed offset positioned on the monopole radiating element divides the monopole radiating element in a first part and a second part to provide at least one complementary frequency band additional to the FM frequency band. The FM frequency band and the at least one additional complementary frequency band are fed through the feed.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 schematically illustrates an antenna device in a portable radio communication device according to a first embodiment.

FIG. 2 illustrates a detailed implementation of an antenna device in a portable radio communication device according to the first embodiment.

Corresponding reference numerals indicate corresponding parts throughout the several views of the drawings.

### DETAILED DESCRIPTION

Example embodiments will now be described more fully with reference to the accompanying drawings.

Exemplary embodiments are disclosed of an antenna device for a portable radio communication device, which allows the portable radio communication device to be provided with a plurality of complementary antennas. In an exemplary embodiment, a monopole FM antenna can be provided in a portable radio communication device, such as a mobile phone, e.g. along an edge of the mobile phone.

A monopole FM antenna is typically positioned oppositely of a cellular antenna in the mobile phone. By having the monopole FM antenna covering an edge of the mobile phone and wherein the monopole FM antenna is being fed in a corner of the mobile phone, optimal performance is expected by utilizing the maximum length of a ground plane of the mobile phone along the diagonal of the ground plane. Such a monopole FM antenna utilizes much of the available space of a portable radio communication device, such as a mobile phone. Other useful complementary antennas in a mobile phone are, for example, Bluetooth (BT), GPS, and WLAN antennas.

A possible solution for adding e.g. BT/GPS function to the FM antenna is to add BT/GPS branches to the FM antenna. But this possible solution would take up more space in the mobile phone, which is undesirable. This possible solution would also risk causing unwanted resonances, which degrade antenna isolation to cellular antennas in the mobile phone. In mobile phones today, an upper edge of the mobile phone is many times 50 millimeters (mm) long or even 60 mm long. Such lengths are not suitable for BT and GPS frequencies. But if the monopole FM antenna would be shortened to not cover an edge of the mobile phone, FM performance would be degenerated in an undesirable way.

By feeding the monopole FM antenna offset from the corner of the mobile phone, it has surprisingly been found that the FM performance is not noticeably degraded. And, it is then possible to feed the monopole FM antenna with at least one, and preferably two, complementary frequency bands apart from the FM frequency band without risking e.g. degraded antenna isolation to cellular bands.

According to aspects of the present disclosure, exemplary embodiments are disclosed of an antenna device for a portable radio communication device, comprising a monopole radiating element to be positioned along one end of the portable radio communication device. The monopole radiating element is configured for operation of a plurality of complementary frequency bands including the FM frequency band. A feed offset positioned on the monopole radiating element divides the monopole radiating element in a first part and a second part to provide at least one complementary frequency band additional to the FM frequency band, which FM frequency band and the at least one additional complementary frequency band are fed through the feed.

In exemplary embodiments, the monopole radiating element preferably covers the whole length of one end of the portable radio communication device for good FM performance. The monopole radiating element is preferably positioned at most 5 mm from the one end for optimal FM performance.

With, for example, a mobile phone having width of about 50 mm, two preferably additional complementary frequency bands are BT and GPS in exemplary embodiments. For good isolation between the complementary bands and the cellular frequency bands of the portable radio communication device, the portable radio communication device preferably comprises a separate radiating element for cellular frequency bands positioned along another end of the portable radio communication device opposite the one end in which the complementary radiating element is positioned.

For implementation of three complementary antennas on a single monopole radiating element in exemplary embodiments, the antenna device preferably comprises a diplexer connected to the feed through matching means for the at least two additional complementary frequency bands. A LNA is connected to the feed through matching means for the FM frequency band.

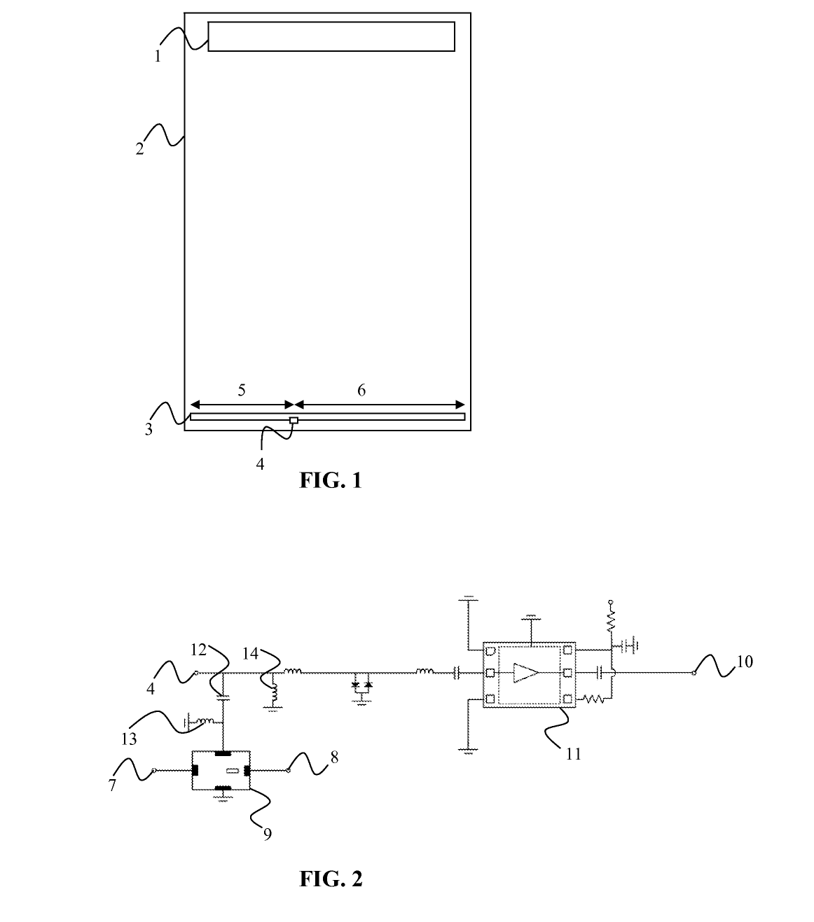

An exemplary embodiment of an antenna device for a portable radio communication device will now be described with reference to FIGS. 1 and 2. As shown, the antenna device comprises a monopole radiating element 3 to be positioned along one end of the portable radio communication device, for operation of a plurality of complementary frequency bands including the FM frequency band.

The antenna device further comprises a feed 4 offset positioned on the monopole radiating element 3 dividing it in a first part 5 and a second part 6 in order to provide at least one, preferably two, complementary frequency bands additional to the FM frequency band. The FM frequency band and the at least one, preferably two, additional complementary frequency bands are fed through the common feed 4.

In this way, the FM frequency band is offset fed for the whole monopole radiating element 3, which preferably covers the whole end of the portable radio communication device, which is exemplified as mobile phone 2 in the following description.

FM performance is optimized or improved by preferably having the monopole radiating element 3 covering the whole end of the phone 2. The feed 4 is preferably positioned such that the first part 5 is about λ/4 long for a first additional complementary frequency band, such as BT. The second part 6 would for a 50 mm wide mobile phone then be about λ/4 long for a second additional complementary frequency band, such as GPS. By having both additional complementary frequency bands radiated from the monopole FM radiating element in the basic resonances, minimal or reduced coupling to cellular frequency bands in a radiating element 1 in an opposite end of the mobile phone 2 is achieved.

For further optimization of FM performance, the monopole FM radiating element 3 is preferably positioned close to the edge of the mobile phone 2, preferably less than 5 mm inward from the edge of a ground plane of the mobile phone 2. It may also protrude out from that edge.

For feeding of the monopole radiating element 3 by three simultaneous complementary frequency bands, preferably FM, BT, and GPS, the following configuration is preferably used. The feed 4 of the radiating element 3 is connected to a diplexer 9 through matching means 12 and 13 for the BT and GPS frequency bands. The matching means 12 and 13 are preferably dimensioned to comprise a capacitor (e.g., 1 picofarad (pF) series capaciator, etc.) in order to block FM frequencies from reaching BT and/or GPS receivers, such that BT and GPS are decoupled from FM. The diplexer 9 is, in turn, connected 7 to a BT transceiver and connected 8 to a GPS receiver. The feed 4 is also connected to a LNA 11 through matching means 14 for the FM frequency band. The LNA 11 is, in turn, connected 10 to an FM receiver/transceiver. The matching network preferably also comprises an Electrostatic Discharge (ESD) protection, Radiated Spurious Emission (RSE) filtering, and low-pass filter for cellular cross-talk reduction components.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms (e.g., different materials, etc.), and that neither should be construed to limit the scope of the disclosure. In some example embodiments, well-known processes, well-known device structures, and well-known technologies are not described in detail. In addition, advantages and improvements that may be achieved with one or more exemplary embodiments of the present disclosure are provided for purpose of illustration only and do not limit the scope of the present disclosure, as exemplary embodiments disclosed herein may provide all or none of the above mentioned advantages and improvements and still fall within the scope of the present disclosure.

Specific dimensions, specific materials, and/or specific shapes disclosed herein are example in nature and do not limit the scope of the present disclosure. The disclosure herein of particular values and particular ranges of values (e.g., frequency ranges or bandwidths, etc.) for given parameters are not exclusive of other values and ranges of values that may be useful in one or more of the examples disclosed herein. Moreover, it is envisioned that any two particular values for a specific parameter stated herein may define the endpoints of a range of values that may be suitable for the given parameter (i.e., the disclosure of a first value and a second value for a given parameter can be interpreted as disclosing that any value between the first and second values could also be employed for the given parameter). Similarly, it is envisioned that disclosure of two or more ranges of values for a parameter (whether such ranges are nested, overlapping or distinct) subsume all possible combination of ranges for the value that might be claimed using endpoints of the disclosed ranges.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items. The term “about” when applied to values indicates that the calculation or the measurement allows some slight imprecision in the value (with some approach to exactness in the value; approximately or reasonably close to the value; nearly). If, for some reason, the imprecision provided by “about” is not otherwise understood in the art with this ordinary meaning, then “about” as used herein indicates at least variations that may arise from ordinary methods of measuring or using such parameters. For example, the terms “generally”, “about”, and “substantially” may be used herein to mean within manufacturing tolerances.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath”, “below”, “lower”, “above”, “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements, intended or stated uses, or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed:

1. An antenna device for a portable radio communication device, the antenna device comprising:
a monopole radiating element to be positioned along one end of the portable radio communication device, for operation of a plurality of complementary frequency bands including the FM frequency band; and
a feed offset positioned on the monopole radiating element dividing the monopole radiating element in a first part and a second part to provide at least one complementary frequency band additional to the FM frequency band, which FM frequency band and the at least one additional complementary frequency bands are fed through the feed.

2. The antenna device of claim 1, wherein the monopole radiating element is configured to cover a whole length of the one end of the portable radio communication device.

3. The antenna device of claim 1, wherein the at least one additional complementary frequency band comprises two additional complementary frequency bands Bluetooth and GPS.

4. The antenna device of claim 1, wherein the portable radio communication device comprises a separate radiating element for cellular frequency bands positioned along another end of the portable radio communication device opposite the one end.

5. The antenna device of claim 1, further comprising:
a diplexer connected to the feed through matching means for the at least one additional complementary frequency band; and
a LNA connected to the feed through matching means for the FM frequency band.

6. The antenna device of claim 5, wherein the matching means for the at least one additional complementary frequency band comprises a capacitor operable for blocking FM frequencies.

7. The antenna device of claim 1, wherein:
the at least one additional complementary frequency band comprises first and second additional complementary frequency bands; and
the feed is positioned such that the first part is about λ/4 long for the first additional complementary frequency band and such that the second part is about λ/4 long for the second additional complementary frequency band.

8. The antenna device of claim 7, wherein:
the first additional complementary frequency band is Bluetooth; and
the second additional complementary frequency band is GPS.

9. The antenna device of claim 7, wherein the first and second additional complementary frequency bands are radiated from the monopole radiating element in basic resonances, such that coupling is reduced to cellular frequency bands in a radiating element in an opposite end of the portable radio communication device.

10. The antenna device of claim 1, wherein the monopole radiating element is positioned at most 5 millimeters inward from the one end.

11. A portable radio communication device comprising the antenna device of claim 1.

12. An antenna device for a portable radio communication device, the antenna device comprising:
a monopole radiating element to be positioned along one end of the portable radio communication device, for operation of a plurality of complementary frequency bands including the FM frequency band;
a feed offset positioned on the monopole radiating element dividing the monopole radiating element in a first part and a second part to provide at least first and second complementary frequency bands additional to the FM frequency band, which FM frequency band and first and second additional complementary frequency bands are fed through the feed;
wherein the feed is positioned such that the first part is about λ/4 long for the first additional complementary frequency band and such that the second part is about λ/4 long for the second additional complementary frequency band.

13. The antenna device of claim 12, further comprising:
a diplexer connected to the feed through matching means for the first and second additional complementary frequency bands; and
a LNA connected to the feed through matching means for the FM frequency band.

14. The antenna device of claim 13, wherein the matching means for the first and second additional complementary frequency bands comprises a capacitor operable for blocking FM frequencies.

15. The antenna device of claim 12, wherein:
the first additional complementary frequency band is Bluetooth; and
the second additional complementary frequency band is GPS.

16. A portable radio communication device comprising an antenna device of claim 12, wherein:
the monopole radiating element is configured to cover a whole length of the one end of the portable radio communication device;
the portable radio communication device further comprises a separate radiating element for cellular frequency bands positioned along another end of the portable radio communication device opposite the one end;
the first and second additional complementary frequency bands are radiated from the monopole radiating element in basic resonances, such that coupling is reduced to the cellular frequency bands in the separate radiating element; and
the monopole radiating element is positioned at most 5 millimeters inward from the one end.

17. A portable radio communication device comprising:
a monopole radiating element positioned along one end of the portable radio communication device for operation of a plurality of complementary frequency bands including the FM frequency band; and
a feed offset positioned on the monopole radiating element dividing the monopole radiating element in a first part and a second part to provide at least one complementary frequency band additional to the FM frequency band, which FM frequency band and the at least one additional complementary frequency bands are fed through the feed.

18. The portable radio communication device of claim 17, wherein:
the monopole radiating element is configured to cover a whole length of the one end of the portable radio communication device;
the portable radio communication device further comprises a separate radiating element for cellular frequency bands positioned along another end of the portable radio communication device opposite the one end; and
the monopole radiating element is positioned at most 5 millimeters inward from the one end.

19. The portable radio communication device of claim 18, wherein:
the at least one additional complementary frequency band comprises first and second additional complementary frequency bands; and
the feed is positioned such that the first part is about λ/4 long for the first additional complementary frequency band and such that the second part is about λ/4 long for the second additional complementary frequency band.

20. The portable radio communication device of claim 19, wherein:
the first additional complementary frequency band is Bluetooth;
the second additional complementary frequency band is GPS; and
the first and second additional complementary frequency bands are radiated from the monopole radiating element in basic resonances, such that coupling is reduced to the cellular frequency bands in the separate radiating element in the opposite end of the portable radio communication device.
